(19) United States
(12) Patent Application Publication
(10) Pub. No.: US 2017/0360008 A1
(43) Pub. Date: Dec. 21, 2017

(54) Self-contained, retractable leash and collar or harness assembly

(71) Applicant: Ciara Young, Naples, FL (US)

(72) Inventor: Ciara Young, Naples, FL (US)

(21) Appl. No.: 15/188,050

(22) Filed: Jun. 21, 2016

(51) Int. Cl. A01K 27/00; B65H 75/40

(52) U.S. Cl. CPC A01K 27/004; B65H 75/406; A01K 27/001; A01K 27/002; A01K 27/005

(57) ABSTRACT

A retractable leash and collar/harness assembly. The assembly includes a flexible handle with a hub assembly in the forward end thereof. The hub assembly contains a spring member and leash line coiled and enclosed within the hub. The leash line is connected to a collar or harness and the handle and collar or harness include a connector thereon to allow the components to be nested each other and folded to provide a compact retractable leash and collar/harness assembly which is easily transportable by the user.

### BACKGROUND OF THE INVENTION

### 1. Field of the Invention

This invention relates, generally, to animal leashes. More particularly, it relates to a self-contained assembly containing a collar or harness with a handle haying a built-in retractable animal leash.

### 2. Description of the Prior Art

Pet collars and harnesses for use with dogs and/or cats having integral leashes are well-known in the art. For example, U.S. Patent App. Pub. No. 2008/0163830 describes a retractable leash and collar assembly, wherein the leash is contained within a housing integrated into the surface of the collar. The housing feeds into an aperture that allows the leash to enter and exit the collar.

U.S. Patent App. Pub. No. 2009/0255486 describes a combination pet collar and leash. The collar assembly communicates with the leash and handle assembly. The collar assembly has a circular housing thereon which contains a retraction mechanism that biases a spool to rotatably receive the leash. The handle can be fastened to the collar and Eos in over relation to the collar and spool when in a retracted position.

U.S. Patent App. Pub. No. 2010/0251970 describes a retractable leash and collar assembly, wherein the leash is contained within a housing integrated into the surface of the collar. The housing feeds into the aperture on the collar that allow s the leash to enter and exit the collar.

U.S. Patent App. Pub. No 2011/0023794 describes an assembly comprising an adjustable collar and retractable leash. The leash is located within a housing on the collar and is wound about a spring-actuated spool. At the other end, the leash is attached to a handle that aesthetically forms a side of the housing when in a retracted position.

U.S. Patent App. Pub. No. 2041/0174238 describes a collar and retractable leash assembly. The collar has a pouch coupled thereto with a retraction assembly contained therein. A cord is connected to the retraction assembly and is wound within the pouch when the apparatus is in a retracted position. A handle is coupled to the end of the cord opposite from the retraction assembly. In the retracted position, the handle is substantially contained within the pouch as well.

U.S. Pat. No. 3,477,410 describes a collar and retractable leash wherein the spring loaded spool portion of the retractable leash is clipped to the collar with a snap lock. The handle and leash are then pulled from the spool which is attached to the collar.

U.S. Pat. No. 4,018,189 describes a retractable dog leash wherein a spring actuated casing includes the retractable leash therein and the handle of the leash extends from the casing and may be pulled to the extended position of the leash. The casing is described as being attached to the collar by a split ring or similar member.

U.S. Pat. No. 6,481,382 describes a collar and self-retracting leash assembly. In a retracted position, the leash is disposed within the collar along the collar's longitudinal axis. A pulley is also disposed within the collar to facilitate expansion of the leash.

U.S. Pat. No. 6,581,547 describes a pet collar with integrated retractable leash. One end of the leash is attached to a coiled spring, and the other end is attached to the handle. In a retracted position, the leash has a portion fastened to the surface of the collar, and the handle is coupled to the collar as well.

U.S. Pat. No. 7,461,615 describes a pet harness with retractable leash secured to the harness, so that the retractable leash is readily accessible on the pet's back. The leash is disposed within a housing, within which the leash is wound around a spool. The handle of the leash is disposed outside of the housing in the retracted position.

U.S. Pat. No. 7,610,880 describes a retractable leash assembly mounted to a collar or harness, wherein the leash is wound about a spool in a housing in the retracted position and is extendable from the spool in an extended position. The handle remains along the exterior of the housing when retracted.

U.S. Pat. No. 8,919,293 describes a retractable leash assembly that forms an integral part of the dog collar wherein the leash extends through a portion of the collar and is wound around a spool in the collar. In one form, the handle of the leash is mountable onto the harness or collar.

The conventional art presents a variety of problems, in particular the conventional leash and collar assembly is cumbersome and inconvenient to be carried by the animal. Accordingly, what is needed is a user-friendly and efficient leash and collar or harness assembly that is compact and does not need to be carried by the animal.

While certain aspects of conventional technologies have been discussed to facilitate disclosure of the invention. Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for an inclusive, accessible animal leash and collar or harness assembly is now met by a new, useful and nonobvious invention.

The novel structure includes a retractable leash and collar or harness assembly. The leash and handle assembly includes a hub member preferably fully contained therein. The hub assembly preferably has a hollow interior, and a spring (e.g., power spring) with a leash line coiled and enclosed within the hub assembly. The spring and leash line remain in communication with each other. The handle preferably surrounds and includes the hub assembly sewn or otherwise enclosed therein. The leash line extends from the forward end of the handle and is preferably interconnected to the collar assembly. In the preferred form of the collar assembly, at least one snap buckle, parachute buckle or similar connector allows the collar to be attached around the neck or body of the animal. Similarly, a harness assembly may be used to maintain control of the animal and is similarly connected to the leash line.

More particularly, the novel retractable leash and handle assembly includes a hub assembly enclosed within the forward end of the handle. The hub assembly has a substantially hollow interior and an aperture formed in the hub. A coiled spring is enclosed within the hollow interior of the hub assembly. The coiled spring has a first end secured to the hub assembly and is biased to be retracted around the hub assembly. The coiled leash line is enclosed within the hollow interior of the hub assembly in the retracted position. The coiled spring has a second end secured to a first, inner end of the coiled leash line. A second, outer end of the coiled leash line extends through the aperture formed in the hub assembly and is disposed externally of the hollow interior of the hub assembly and through the forward end of the handle.

In a further embodiment, the hub assembly may have a notched channel along its circumference, and the leash line would be coiled around the hub assembly within the notched channel. The hub assembly may also include a push button or similar actuation mechanism to allow the user to stop the extension of the leash from the hub assembly at any desired length.

The collar assembly or harness assembly include one or more connectors to allow the respective component to be securely connected around the neck or body of the animal. The collar or harness assembly also includes a further connector to connect the handle and hub assembly component to the collar or harness when the novel assembly is not in use. In a preferred form of this invention, the connection may be a magnetic connection such that the handle is easily attached or removed from the outer surface of the collar. Another snap type connector may be provided on the exterior of the collar to allow the user to connect certain swag type items such as bows, sparkles or other distinctive items. In a preferred form of the present invention, the leash line extends from the handle to a leash connector that is sewn into the collar assembly such that the leash line is integrally connected to the collar assembly. In a preferred form of the harness assembly, the harness include the hub assembly therein and the leash line is integrally connected to the handle.

The novel retractable leash and collar assembly is preferably constructed of a flexible and lightweight material to allow the handle with the hub assembly therein to be folded and releasably attached to the flexible and foldable collar or harness to allow the overall assembly to be compactly and easily carried by the user in a pocket or purse. Alternately, the handle and hub assembly is sufficiently small and lightweight so that it may be releasably attached to the collar or harness by a connector such as a magnet, button, snap or hook and loop connector without interfering with the movement of the animal. Preferred materials include durable fabrics, woven canvas or Kevlar type materials.

In an alternate embodiment, the current invention comprises a retractable leash and harness assembly for a pet. The leash and harness assembly includes a hub with hollow interior, and a spring (e g., power spring) and leash line coiled and enclosed within the hub. The spring and leash line remain in communication with each other in the interior of the harness and the leash line extends to the handle. The harness is of a conventional configuration that fits around the body of the animal and is connected with one or more snap or parachute type connectors. The leash is preferably integrally connected to the harness and includes a connector that is integrally located in the forward end of the handle.

A hollow tubing or channel may be disposed within and longitudinally along the forward end of the handle. This channel allows the user to hold the handle while also controlling the release of the leash from the hub assembly through the forward end of the handle. The spring and leash line may be positioned in the hub assembly such that the spring and leash line are coiled around the housing assembly, and the spring is in communication with the interior of the housing assembly. In a further embodiment, the hub assembly may have a notched channel along its circumference, and the leash line would be coiled around the hub assembly within the notched channel. In yet another embodiment, the hub assembly may include a push button or compressible configuration to allow the user to stop the release of the leash from the hub assembly at a desired length. In one form, depression of the button causes the leash to be pinched in the hub assembly such that movement of the leash from the hub assembly is stopped.

These and other important objects, advantages, and features of the invention will become clear as this disclosure proceeds. The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the nature and objects of the invention, reference should be made to the following detailed disclosure, taken in connection with the accompanying drawings, in which:

FIG. 1 is a top perspective view of the retractable leash assembly of the present invention.

FIG. 2 is another perspective view of the retractable leash assembly of the present invention.

FIG. 3 is an enlarged view of the handle of the retractable leash assembly according to an embodiment of the current invention.

FIG. 4 is a perspective view of the collar of the retractable leash assembly.

FIG. 5 is a further perspective view of the collar of the retractable leash assembly.

FIG. 6 is a perspective view of the retractable leash assembly showing the leash extended.

FIG. 7 is a perspective view of the folded collar of the retractable leash assembly.

FIG. 8 is a perspective view of the folded handle and collar of the retractable leash assembly.

FIG. 9 is a perspective view of the retractable leash assembly with a harness.

FIG. 10 is a perspective view of the hub assembly shown partially in the forward end of the handle of the present invention.

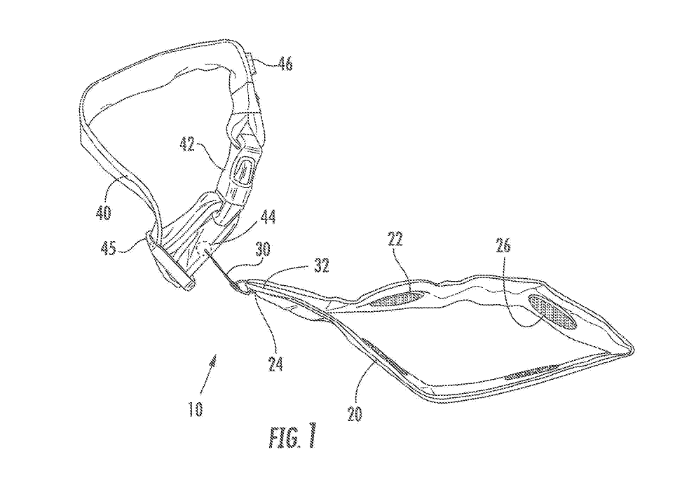

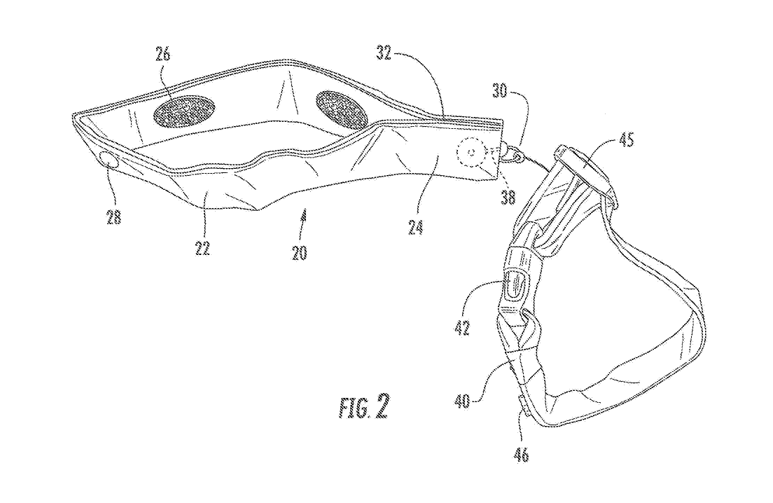

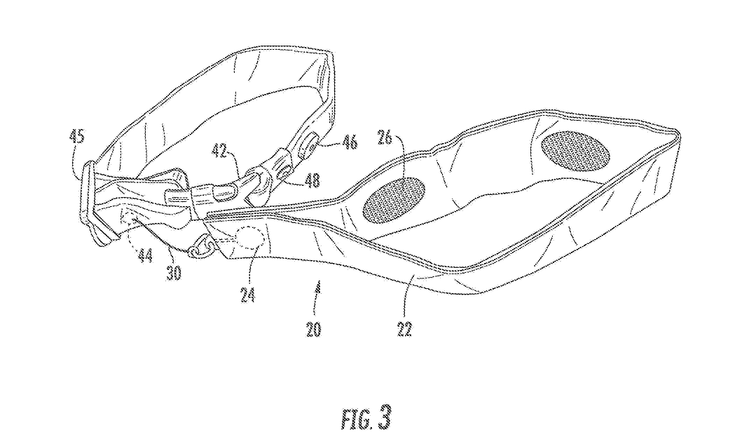

### DETAILED DESCRIPTION OF THE PREFERRED EMBODIMENT

In the following detailed description of the preferred embodiments, reference is made to the accompanying drawings, which form a part thereof, and within which are shown by way of illustration specific embodiments by which the invention may be practiced it is to be understood that other embodiments may be utilized and structural changes may be made without departing from the scope of the invention.

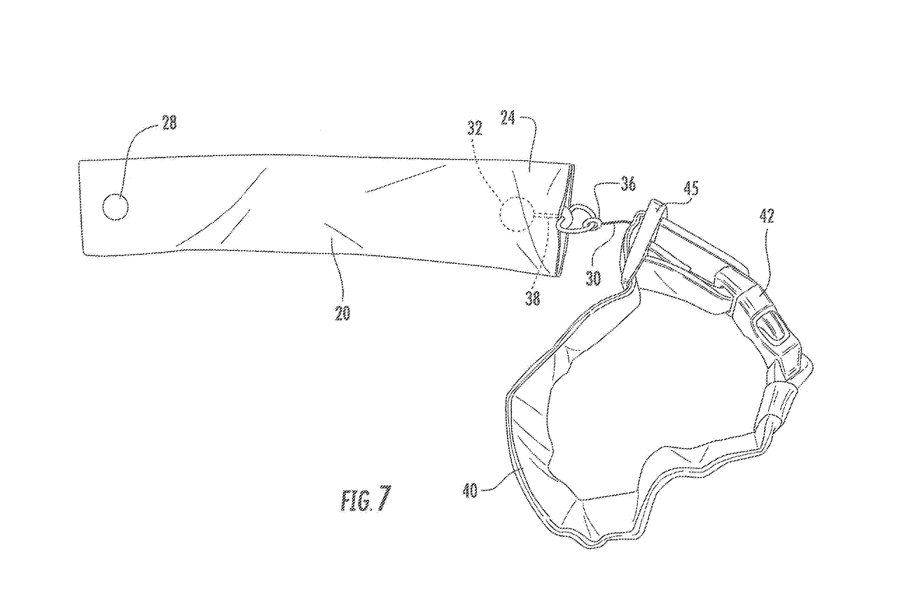

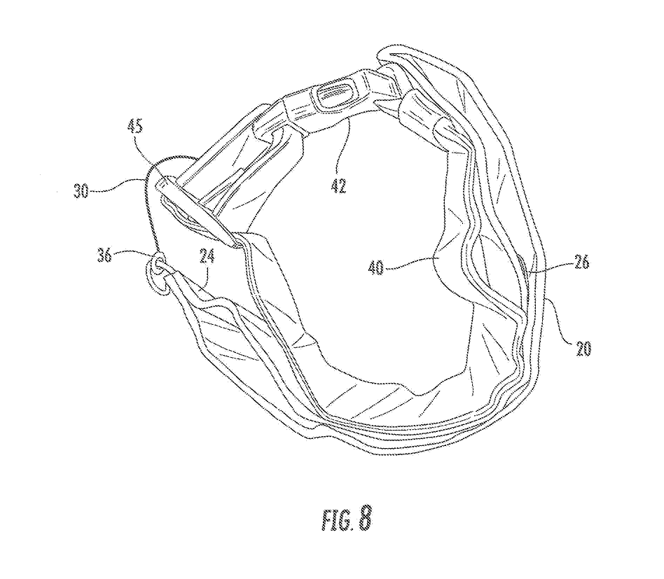

In an embodiment, the current invention includes a retractable leash and collar assembly 10 consisting generally of a handle 20, leash 30 and collar 40. The handle 20 includes the hub assembly 32 contained in the forward end 24 thereof. The hub assembly is generally denoted as a whole component in the Figures by the reference numeral 32. The handle 20 is preferably configured with a loop portion 22 and a forward end 24. The loop portion may include a hook and loop material or similar type of connecting configuration to form an interior connector 26 to allow the user to fold the loop portion 22 of the handle 20 on itself as shown In FIG. 7. The exterior of the handle also preferably includes an exterior connector 28 such as a magnet, button, snap or hook and loop material to allow the handle 20 to be releasably attached to a complementary connector on the exterior of the collar as shown in FIG. 8. In a preferred form of the present invention, the handle extends around at least three fourths of the exterior of the collar to provide a compact leash and collar assembly 10. Additionally, because of the flexibility of the materials used for construction, the entire retractable leash and collar assembly 10 may be folded over itself again to provide a compact assembly which is readily transportable in the pocket or purse of the user.

The forward end 24 of the handle 20 fully encloses and retains the hub assembly 32 therein. A passageway 38 extends from the hub assembly 32 to the front of the forward end 24 of the handle 20 to allow the leash 30 to movably pass there through. The leash 30 extends from the lead connector 36 adjacent to the handle 20 to the lead end 34 which is adjacent to the collar 40. In a preferred form of the present invention, the handle is formed of a flexible material that is lightweight and foldable. It is anticipated that the handle may be made of a fabric material and may potentially also include a reinforcing material therein to increase the durability of the handle while not limiting the flexibility and foldability of the handle 20.

The hub assembly 32 can be formed of any suitable material, for example metal, plastic, carbon fiber, etc. Examples of commercially availability components that are suitable for use as a hub assembly include Carabiner retractable reels manufactured by Universal Mercantile Exchange, Inc. of Walnut, Calif. or retractable lifelines manufactured by Global Equipment Co., Inc. of Buford, Ga. The hub assembly 32 includes capsule section, which encloses a reel/spring housing assembly. The hub assembly 32 not only houses the capsule but also encloses the spring member and the leash line when the leash is retracted. The spring is a conventional spring that is wound or coiled around the capsule to bias the leash line to a retracted position. The spring may have an inner end connection attached to the interior of the capsule. The opposite end of the spring terminates in the leash line 30, which in turn leads to and is interconnected to the lead end 34 that is preferably integrally attached to the collar 40 at the leash connector 44. The leash line 30 may alternately be wound around an outer groove on the capsule in outer relation to a spring.

One ordinary skill in the art would be capable of optimizing size/diameter of the size/diameter of hub assembly 32, width of hub assembly, turns of the spring required, torque required within hub assembly 32, among other optimizing factors when considering the life cycle required of the apparatus, environment in which the spring is used (e.g., frequent winding and unwinding due to leash 30, retracting in and out of the capsule), etc. The exterior of the hub assembly 32 may also have a sloped plane to facilitate the spooling of leash line 30. The hub assembly may also be formed of a pair of nesting components such that when the components are squeezed together by the user, the leash line 30 may be pinched there between to prevent an additional length of the leash line from being drawn from the hub assembly 32.

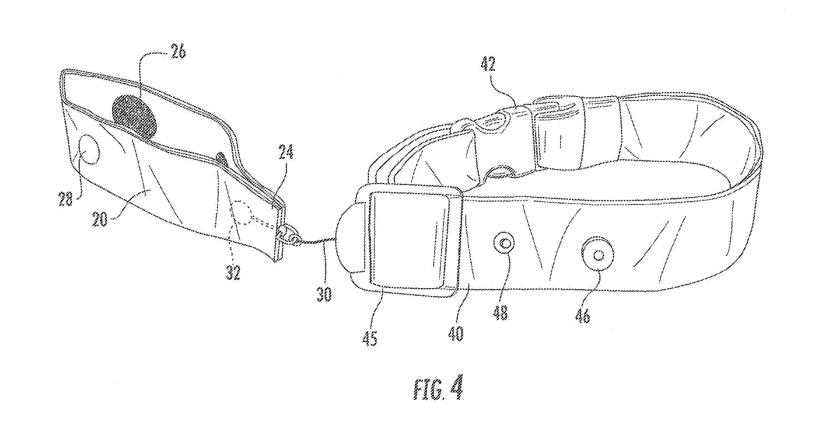

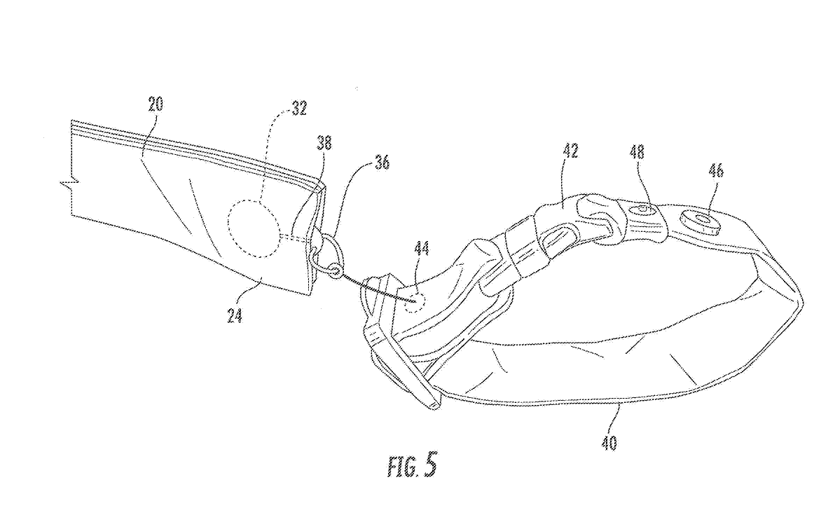

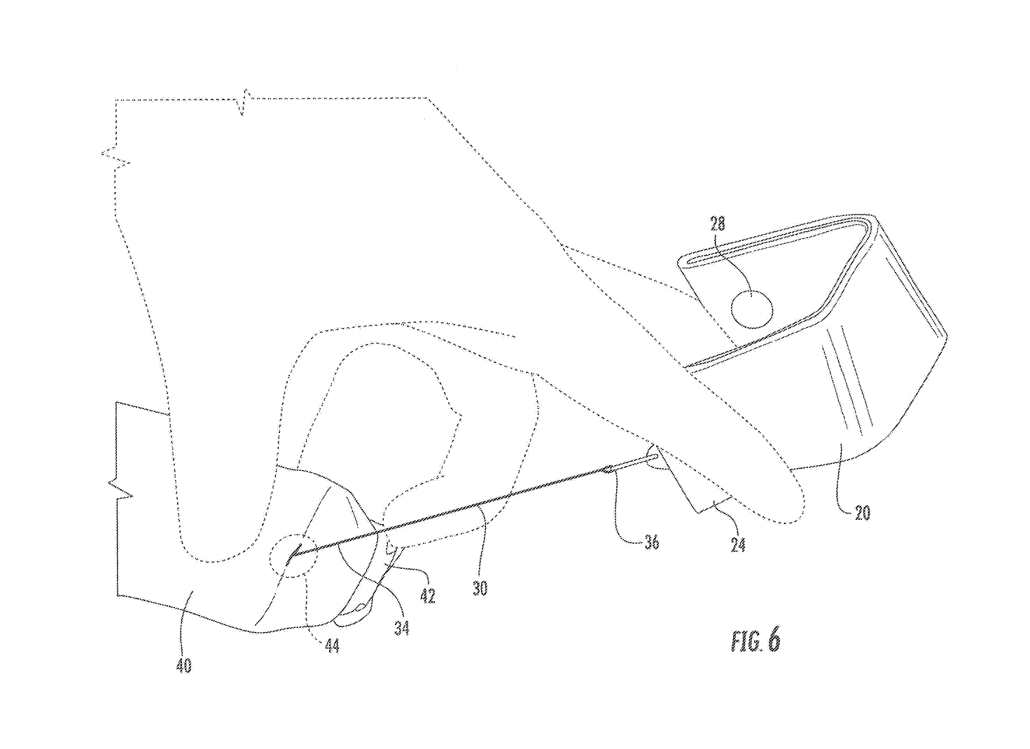

The collar is generally illustrated FIGS. 4 and 5 and is designated generally by the reference number 40. The collar 40 includes a clasp 42, leash connection 44, an adjustable connector 45, a handle connector 46 and a swag connector 48. The collar 40 is preferably made of a flexible material that may include additional reinforcing materials to increase the durability while not adversely affecting the flexibility. In one form of the invention, the clasp 42 and leash connection 44 are located general adjacent to each other, although they may be further spaced apart without affecting the functionality of the present invention. The leash connection 44 is preferably integrally connected or sewn into the collar 40 so that the user need not clip or otherwise attach the leash to the collar. The handle connector 46 is preferably a magnet or similar member that is located on the exterior surface of the collar 40 to provide a convenient location to attach the exterior connector 28 of the handle 20 thereto. The collar 40 may also contain an additional swag connector 48 that consists of a snap type connector to allow bows, sparkles or other distinctive materials to the collar. The collar 40 may also include an adjustable connector 45 to allow the collar to be adjusted to a pet's size via an adjustable slide mechanism. In general function (e g., installation onto the pet and adjustability), the collar 40 can be utilized similar to conventional pet collars, and as such includes the appropriate straps and configuration for adjustability. Additionally, the leash connection 44 of the collar 40 and the lead connector 34 of the handle 20 are preferably integrally connected to provide an overall leash and collar assembly that is a unitary integral component that is easily folded for compact carrying by the user as shown in FIG. 8.

The retractable leash and collar assembly is generally denoted in the Figures as reference numeral 10. The collar 40 is attached to the animal by wrapping the collar around the animal and using the clasp 42 to retain the collar around the animal. The leash line 30 is then removed from the collar 40 by grasping the handle and removing the handle connector 46 from the exterior connector 28. The user can then allow the leash to be withdrawn from the hub assembly 32 by holding the handle and allowing the animal to walk away from the user. An advantage of the present invention is that as the leash is withdrawn from the hub assembly 32, the pet does not feel the vibration of the leash being withdrawn from the hub assembly on their back or around their neck. In the alternate form of the present invention, if the user wants to stop the extension of the leash, they may compress the hub assembly to stop the leash.

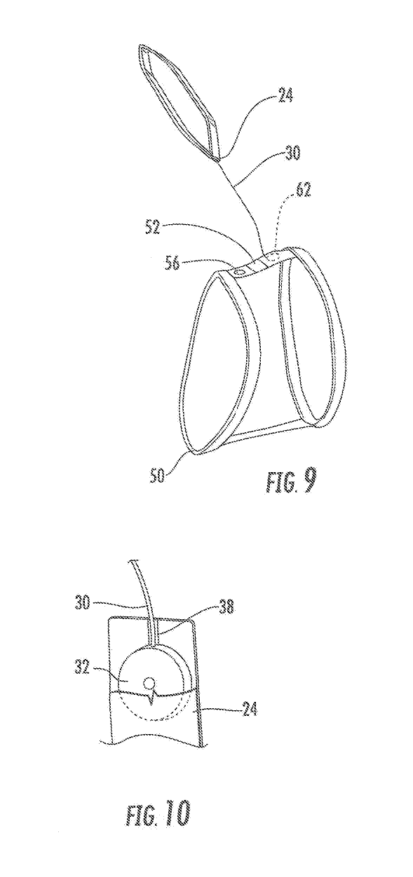

The harness form of the present invention is generally illustrated in FIG. 9. The harness is designated generally by the reference number 50. The harness 50 includes a pair of clasps 52 and a handle connector 56. The harness 50 is preferably made of a flexible material that may include additional reinforcing materials to increase the durability while not adversely affecting the flexibility. In one form of the invention, the clasps 52 are located generally spaced apart from a hub assembly 62 that is preferably integrally sewn into the harness 50, although the clasps 52 and hub assembly 62 may be located generally adjacent to each other without affecting the functionality of the present invention. The handle connector 56 is complementary to an exterior connector 28 on the handle 20 and is located on the exterior surface of the harness 50 at a convenient location to attach the exterior connector 28 of the handle 20 thereto. When attached to the pet, the clasps 52, handle connector 56 and hill assembly are 62 are preferably located along the back of the animal. The harness 50 may also include an adjustable feature to allow the harness to be adjusted to a pet's size via an adjustable slide mechanism. In general function (e.g., installation onto the pet, adjustability), harness 50 can be utilized similar to conventional pet harnesses, and as such includes the appropriate straps and configuration for adjustability. Although the preferred form of the harness shown as including the hub assembly 62 integrally connected to the forward end 24 of the handle 20, an alternate form of the harness 50 may be interchangeable for customization and include an additional connector for personalization.

1. A retractable pet leash, comprising:
a flexible loop shaped handle member haying a forward end;
a hub assembly disposed in the forward end of the handle member wherein the hub assembly includes a spring biased member connected to a first end of a leash line;
an opening in the forward end of the handle member to allow the leash line to extend therethrough in response to the extension and retraction of the leash line from the hub assembly;
the leash line is an elongated leash element having an attachment portion at a second end thereof configured to be coupled to a collar or harness on an animal;
a spool member disposed within the hub assembly and arranged to rotate about an axis to release or retract the leash element wrapped about the spool member, wherein the spool member is rotatably biased to retract the leash element within the housing; and
a collar sized and configured to be placed around the neck of an animal wherein the collar includes a snap connector to allow the collar to be retained around the neck of the animal and a leash line connection adapted to retain the second end of the leash line on the collar.

2. The retractable pet leash according to claim 1, wherein the handle member has a generally loop shape and a connector located on the surface along the interior of the loop shape to allow the handle to be closed for folding

3. The retractable pet leash according to claim 1, wherein the exterior surface of the handle member has a connector thereon to allow La the attachment of the handle member to a complementary connector on the collar.

4. The retractable pet leash according to claim 3, wherein the handle member is foldable along the outer surface of the collar and each of the handle member and collar are further foldable to provide a compact retractable leash assembly.

5. The retractable pet leash according to claim 1, wherein the hub assembly includes at least one compressible pressure element disposed thereon, to restrict the passage of the leash line from the hub assembly when the pressure element is depressed.

6. A retractable pet leash, comprising:
a flexible loop shaped handle member having a forward end;
a collar sized and configured to be placed around the neck of an animal wherein the collar includes a snap member to allow the collar to be retained around the neck of the animal;
a leash line including an elongated leash element having an attachment portion at a second end thereof configured to be coupled to the other of the collar or handle member leash line and another connection adapted to retain a second end of the leash line on the other of the collar or leash line;
a hub assembly disposed in one of the handle member or collar wherein the hub assembly includes a biased member connected to a first end of a leash line;
an opening adjacent to the hub assembly to allow the leash line to extend therethrough in response to the extension and retraction of the leash line from the hub assembly; and
wherein the exterior surface of the handle member has connector on an exterior surface thereof to allow for the attachment of the handle member to a complementary connector on the collar.

7. The retractable et leash according to claim 6, wherein the handle member has a connector located on the surface along the interior of the loop shape to allow the handle to be closed for folding.

8. The retractable pet leash according to claim 8, wherein the handle member is foldable along the outer surface of the collar and each of the handle member and collar are further foldable to provide a compact retractable leash assembly.

9. The retractable pet leash according to claim 6, the hub assembly includes at least one compressible pressure element disposed thereon, to restrict the passage of the leash line from the hub assembly when the pressure element is depressed.

10. The retractable pet leash according to claim 6, wherein the hub assembly is integrally retained in the forward end of the handle member.

11. A retractable pet leash, comprising:
a flexible loop shaped handle member having a forward end;
a hub assembly disposed in the forward end of the handle member wherein the hub assembly includes a biased member connected to a first end of a leash line;
an opening in the forward end of the handle member to allow the leash line to extend therethrough in response to the extension and retraction of the leash line from the hub assembly;
wherein the leash line is an elongated hash element having an attachment portion at a second end thereof configured to be integrally coupled to a collar on an animal;
a collar sized and configured to be placed around the neck of an animal wherein the collar includes a snap member to allow the collar to be retained around the neck of the animal; and
wherein the exterior surface of the handle member has connector on an exterior surface thereof to allow for the attachment of the handle member to a complementary connector on the collar and the handle member has a plurality of connectors located on the surface along the interior of the loop shape to allow the handle to be closed for folding.

12. The retractable pet leash according to claim 11, wherein the handle member is foldable along the outer surface or the collar and each of the handle, member and collar are further foldable to provide a compact retractable leash assembly.

13. The retractable pet leash according to claim 11, wherein the hub assembly includes at least one compressible element disposed thereon, to restrict the passage of the leash line from the hub assembly when the pressure element is depressed.

14. The retractable pet leash according to claim 1, wherein the collar includes a further connector thereon to allow decorative items to be attached thereto.

15. The retractable pet leash according to claim 11, wherein the collar includes and exterior surface and the handle is attachable thereto at least three fourths of the length along the exterior surface thereof.
